(19) United States
(12) Patent Application Publication
(10) Pub. No.: US 2025/0075900 A1
(43) Pub. Date: Mar. 6, 2025

(54) FOAM DETECTION TECHNIQUE-ALGORITHM FOR STEAM BOILERS USING LWCO DEVICE

(71) Applicant: Fluid Handling LLC, Morton Grove, IL (US)

(72) Inventors: Prajapati Darshit KANUBHAI, Gujarat (IN); Bhatia Indresh ISHWARLAL, Gujarat (IN); James GU, Buffalo Grove, IL (US); Vinh TRUONG, Hoffman Estates, IL (US)

(21) Appl. No.: 18/822,679

(22) Filed: Sep. 3, 2024

Related U.S. Application Data
(60) Provisional application No. 63/536,201, filed on Sep. 1, 2023.

(51) Int. Cl. F22B 37/46; F22B 35/18; G01F 23/02; G01F 23/80; G01F 25/20

(52) U.S. Cl. CPC F22B 37/46; F22B 35/18; G01F 23/02; G01F 23/80; G01F 25/22

(57) ABSTRACT

A low water cutoff (LWCO) device having a probe features a signal processor or processing module configured to receive signaling containing information about a difference in conductance between samples of a foam/unstable fluid line for a predetermined foam difference count that are measured on at least one test channel and sensed by the probe arranged inside a boiler, including a steam or hot water boiler or burner; and provide corresponding signaling containing information to turn OFF the boiler, based upon the signaling received.

### CROSS-REFERENCE TO RELATED APPLICATION

This application claims benefit to provisional patent application Ser. No. 63/536,201, filed 1 Sep. 2023, which is hereby incorporated by reference in its entirety.

### BACKGROUND OF THE INVENTION

### Field of the Invention

The present invention relates to a foam detection technique; and more particularly to a foam detection technique for a steam boiler using a Low Water Cut Off (LWCO) device.

### Brief Description of Related Art

For a small boiler application and/or low water with high density foam presence, it is tricky to detect unstable fluid line and control the burner.
1. The LWCO device is unable to detect the foam/unstable fluid state from an in-water to a low-water transition at the desired burner cut-off (turning OFF) level.
2. The LWCO device also fails to detect the fluid stable state (may change with fluid type and contaminations) from a low-water to an in-water transition, for the reliable operation of the burner (turning ON) and the feeder (turning OFF).

### Design Configurations

During test, typical design configurations included the following:
ADC samples are taken at every 1 second, where ADC is understood to be Azodicarbonamide, which is used as a foaming agent.
The Delay on Make (DOM) time is 30 seconds for the burner to be started.
The Delay on Break (DOB) time is 5 seconds for the burner to be stopped.

### Boiler Measurement Data Analysis

FIG. 1 shows a graph that indicates a problem known in the art, e.g., where the burner is not cut off at a desired point as marked with a blue line (i.e., where the water level crosses the probe as indicated at about the location 31 on the X axis). Instead, the burner is cut off between the locations 211 and 221 on the X axis.

From this data shown in FIG. 1, the following are observed when the foam reaches to the probe level.
The brown/blue curves/readings/data in FIG. 1 indicate the measurement of the water condition during a water transition around a cut-off threshold.
The green colour curve/reading/data in FIG. 1 indicates the difference between two ADC measurements at the same instance.
Two consecutive ADC data measurements at a difference of 10 msec are shown, if the water level is stable or slowly decreasing, then it should be almost the same; but when the water is in an unstable state/having turbulence, then there will be a difference in these two consecutive ADC data measurements.

Considering the aforementioned problem in the art, there is a need in the industry for a better foam detection technique for a steam boiler using a LWCO device.

### SUMMARY OF THE INVENTION

The inventors determined that, with the help of a differential measurement, one can improve the operational accuracy of burner control at the desired level.

In summary, the present invention provides a new and unique foam detection technique/algorithm for steam boiler using a LWCO device. The technique/algorithm detects the presence of a foam/unstable fluid line using conductance measurement/control which improves the accuracy of the burner operation.

By way of example, the present invention is applicable to Low Water Cut-Offs (FPC-1000) of the assignee of the instant application and specially designed to protect steam boilers from the hazards of low water condition for residential and commercial boiler applications. See the Assignee's Manual, entitled “FPC-1000-Field configurable low-water cut-off for steam and hot water boilers,” which is hereby incorporated by reference.

By way of example, the present invention to detect the presence of unstable fluid state/turbulence includes the following:

According to the present invention, a differential/filtering method of measurement helps to detect the unstable fluid state/turbulence, e.g., either by measuring an independent analog input (i.e., a difference for two successive samples of the same ADC channel), or by measuring redundant analog inputs (i.e., a difference for two ADC channels at the same instant).

### Turn OFF Burner (Low Water Condition)

By way of example, the control functionality to turn OFF the steam burner (Low water conditions) may include using one or more of the following:
1. CH1 measurement difference=(CH1 latest ADC sample−CH1 previous ADC sample), which is restricted to an allowable limit.
2. CH2 measurement difference=(CH2 latest ADC sample−CH2 previous ADC sample), which is restricted to an allowable limit.
3. Also, one may find a maximum peak value of all turbulences, e.g., by comparing the 5 latest measurement values for both the channels CH1 & CH2, which is restricted to the allowable limit. The total sample no. can be changed based on boiler data.

$$4. \% Difference = \frac{Modulus of ( CH 1 measurement - CH 2 measurement )}{CH 1 measurement}$$

$$5. \% Difference = \frac{Modulus of ( CH 1 measurement - CH 2 measurement )}{CH 2 measurement} .$$

### Turn ON Burner (in Water Condition)

By way of example, the control functionality to turn ON the steam burner (In water condition) may include the following:
1. The water level stability is checked by comparing the present ADC Value with the average of previous

$$ADC values = ( \frac{\sum Previous ADC reading ( N )}{N} - Latest ADC reading ) < ( 10 {\%}^{*} of Latest ADC reading )$$

*The percentage value can be changed based on the boiler data, e.g., where N is selected as 5 data samples.

### Specific Embodiment

According to some embodiments, and by way of example, the present invention may include, or take the form of, a low water cutoff (LWCO) device having a probe, featuring a signal processor or processing module configured to
1. receive signaling containing information about a difference in conductance between samples of a foam/unstable fluid line for a predetermined foam difference count that are measured on at least one test channel and sensed by the probe arranged inside a boiler, e.g., including a steam or hot water boiler or burner; and
2. provide corresponding signaling containing information to turn OFF the boiler, based upon the signaling received.

According to some embodiments, the present invention may also include one or more of the following features:

The signaling may contain information about successive samples measured on one test channel. The one test channel may be either a first test channel (CH1) or a second test channel (CH2).

The signaling may contain information about simultaneous samples measured at the same instant on different test channels. The different test channels may be the first test channel (CH1) and the second test channel (CH2).

The signal processor or processing module may be configured to
1. make a comparison, e.g., of at least five samples, and determine a maximum peak value for two test channels; and
2. if the maximum peak value is greater than a predetermined allowable limit, then provide the corresponding signaling containing information to turn OFF the steam boiler.

The signal processor or processing module may be configured to determine a percentage difference based upon the following relationship:

$$\frac{\begin{matrix}Abs ( 1 st test channel measurement - \\ 2 nd test channel measurement )\end{matrix}}{1 st test channel measurement} ;$$

$$or$$

$$\frac{\begin{matrix}Abs ( 1 st test channel measurement - \\ 2 nd test channel measurement )\end{matrix}}{2 nd test channel measurement} ,$$

where Abs is an absolute function in the form of |n| or |−n| equals |n|.

The signal processor or processing module may be configured to
1. make a comparison between a present test measurement and an average of previous test measurement value; and
2. if the comparison is less that a predetermined percentage for a predetermined Delay on Break (DOM) time, then provide the corresponding signaling signaling containing information to turn ON the steam boiler, based upon the comparison.

The signal processor or processing module may be configured to make the comparison based upon the following relationship:

$$\frac{\sum Previous test channel measurements ( N )}{N} ,$$

e.g., where N is at least 5.

### The Method

According to some embodiments, the present invention may take the form of a method to detect the presence of a foam/unstable fluid line in a boiler using a LWCO device having a probe, featuring:
receiving, with a signal processor or processing module, signaling containing information about a difference in conductance between samples of a foam/unstable fluid line for a predetermined foam difference count that are measured on at least one test channel and sensed by the probe arranged inside a boiler, e.g., including a steam or hot water boiler or burner; and
providing, with the signal processor or processing module, corresponding signaling containing information to turn OFF the boiler, based upon the signaling received.

The method may also include one or more of the features set forth herein.

### BRIEF DESCRIPTION OF THE DRAWING

The drawing, which is not necessarily drawn to scale, includes the following Figures:

FIG. 1 shows a graph of a known LWCO operation without using the present invention, which has ADC data that includes different colored plots, including plots of dark blue curves/readings/data showing ADC value channel 1, red curves/readings/data showing ADC value channel 2, light green curves/readings/data showing the ADC difference, purple curves/readings/data showing a burner status, and light blue curves/readings/data showing the burner's water level.

FIG. 2A shows a CheckWaterCondition routine that may be implemented, e.g., every 1 second, having a foam detection algorithm-1 and a foam detection algorithm-2, according to some embodiments of the present invention.

FIG. 2B shows the foam detection algorithm-2 that may be implemented, e.g., every 1 second, according to some embodiments of the present invention.

FIG. 3 shows a block diagram of a test setup, according to some embodiments of the present invention.

FIG. 4A shows a graph of an improved LWCO operation of the FPC-1000 using the present invention, which has different colored plots, including plots of dark blue curves/readings/data showing ADC value channel 1, red curves/readings/data showing ADC value channel 2, light green curves/readings/data showing the ADC difference, and purple curves/readings/data showing a relay signal for turning the burner ON/OFF.

FIG. 4B shows a graph of the improved LWCO operation of the FPC-1000 using the present invention, which has different colored plots, including plots of light green curves/readings/data showing ADC value channel 1, blue curves/readings/data showing ADC value channel 2, purple curves/readings/data showing the ADC difference, and light brown curves/readings/data showing a relay signal for turning the burner ON/OFF, as well as dashed boxes indicating disturbances in the individual ADC data for successive sample Ch1 & Ch2 and a difference between ADC Ch1 & Ch2 amplified at the same instant for turning OFF the burner around sample 50; and also indicating an in-water condition and water stability check for turning ON the burner around sample 162.

FIG. 5 shows a block diagram of a LWCO device, according to some embodiments of the present invention.

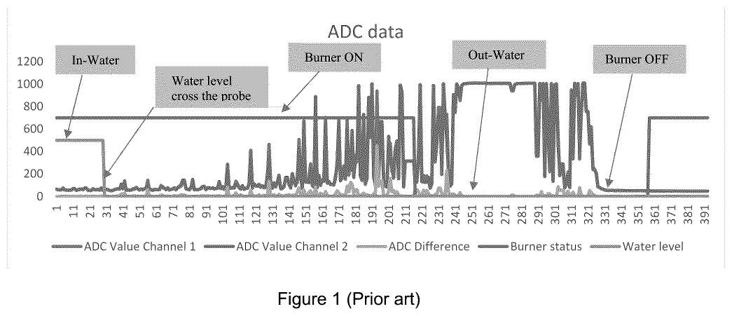

Similar parts in Figures are labeled with similar reference numerals and labels for consistency. Every lead line and associated reference label for every element is not included in every Figure of the drawing to reduce clutter in the drawing as a whole.

The patent or patent application contains at least one drawing executed in color. Copies of this patent or patent application publication with color drawing(s) will be provided by the Patent Office upon request and payment of the necessary fee.

### DETAILED DESCRIPTION OF THE INVENTION

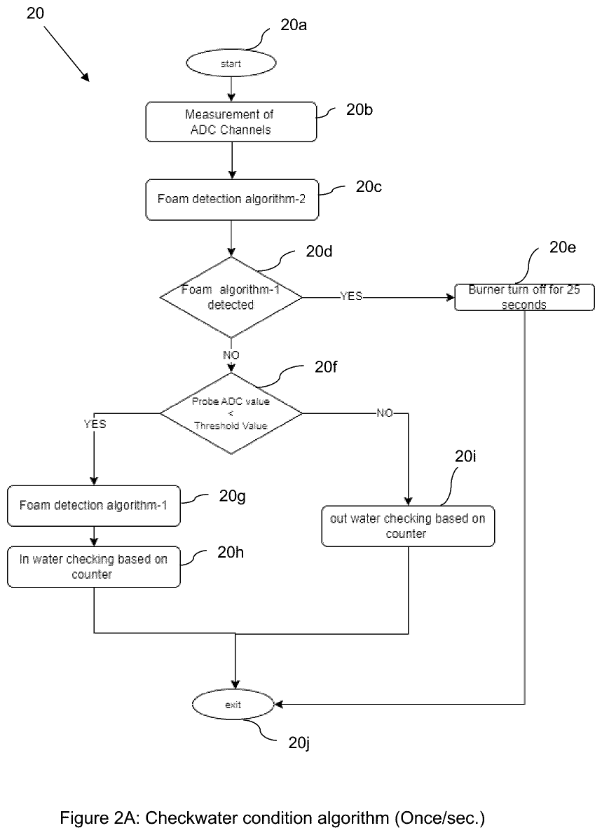

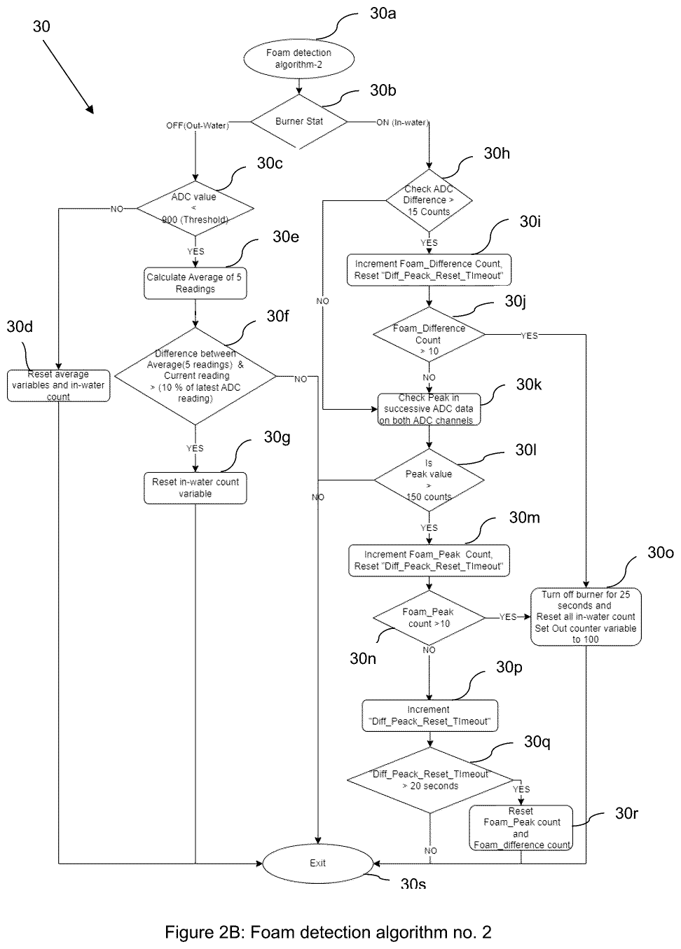

### FIGS. 2A and 2B: Pseudo Flow

By way of example, FIG. 2A shows a CheckWaterCondition algorithm 20 having steps 20a through 20j, while FIG. 2B shows a foam detection algorithm-2 30 having steps 30a through 30s. The CheckWaterCondition algorithm 20 (FIG. 2A) includes steps 20d and 20g for implementing a foam algorithm-1 and also includes a step 20b for implementing a foam detection algorithm-2 that is shown in FIG. 2B.

Consistent with that shown in FIGS. 2A and 2B, the present invention may be implemented based upon the flow charts as follows:

There are two separate algorithms to turn a burner ON/OFF based on the present state of the burner.

For detection of foam in an “in-water” condition, the following two algorithms may be implemented and summarized as follows:

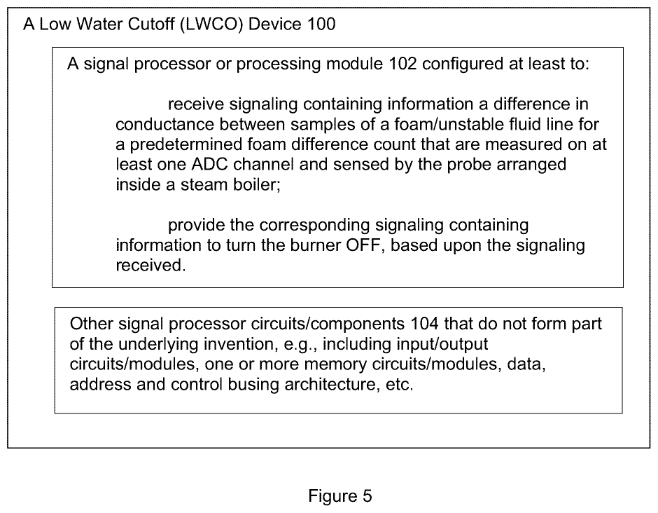

Checking of the ADC difference of Ch-1 and Ch-2 on same instance, if the difference is more than 15 counts, then the “Foam_Difference” counter increments by one. See steps 30h through 30j, which result in the burner being turned OFF in step 30o when a foam_difference count is greater than 10. See FIG. 5B, e.g., showing a difference between ADC CH1 & CH2 amplified at the same instant for turning OFF the burner.

Checking disturbances in the individual ADC data (e.g., by detecting a peak) for successive samples, if the value is more than 150 counts, then the “Foam_peak” counter increments by one. See steps 30k through 30n, which result in the burner being turned OFF in step 30o when a foam_peak count is greater than 10. See FIG. 5B, e.g., showing disturbances in individual ADC data for successive samples CH1 & CH2.

If any of the abovementioned counter incremented values is more than 10 counts, then the presence of foam is detected, and the burner will be turned OFF. See steps 30j and 30n.

If the time between two successive “Foam_Difference” or “Foam_peak” of either ADC channel is more than 20 seconds, then reset the counters relevant to the “Foam Difference” and “Foam peak”. See step 30i and steps 30p through 30r.

From the “out-water” condition to the “in-water” condition, the burner will be turned ON by checking water level stability as follows:

For detecting stability of water, the present ADC value is compared with an average of the previous n ADC samples, and if the difference is more than 10 percent of the actual value, then the “in-water count” will reset to zero, e.g., where n equals 5. See steps 30c through 30g.

If this difference is within 10 percentage of the latest ADC reading for an at least configured DOM time (i.e., the default time is 30 seconds), then the burner will be turned ON again. FIG. 2B does not show a step for turning ON the burner, but it is understood to include the same when step 30f is determined to be NO. See FIG. 5B, e.g., showing an in-water condition and water stability check for turning ON the burner.

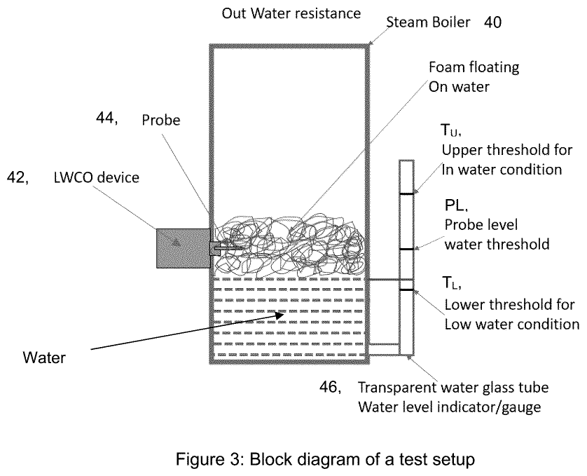

### FIG. 3: The Test Setup

FIG. 3 shows a test setup for implementing the present invention that includes the following:
A steam boiler 40 having foam floating on water contained therein.
An LWCO device 42 having a probe 44 mounted on a wall of the steam boiler 40.
A water gauge 46 also mounted on the steam boiler 40 that indicates the water level inside the enclosed steam boiler, including indications for an upper threshold T_{U}, a lower threshold T_{L} and a probe level P_{L}.

The LWCO device 42 includes a signal processor or processing module 102 (FIG. 6) that may be configured to implement the steps 20a through 20j and the steps 30a through 30s set forth in FIGS. 2A and 2B in conjunction with the test setup shown in FIG. 3.

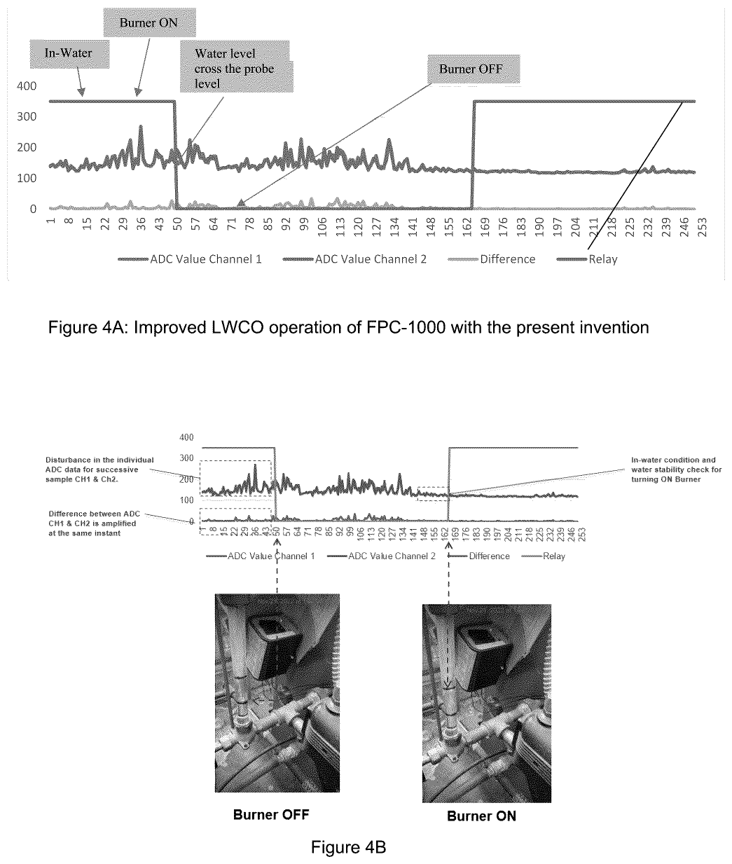

### FIGS. 4A-4B: Testing the Present Invention

FIG. 4A shows a graph having plots of the ADC value channel 1, the ADC value channel 2, the ADC difference between the ADC value channel 1 and the ADC value channel 2, the burner status (ON/OFF) and the water level. Moreover, FIG. 4A includes indications when the probe 44 (FIG. 3) is in-water, where the water level crosses the probe, when the burner 40 (FIG. 3) is turned ON/OFF, when the probe is out-of-water.

In contrast, FIG. 4B shows a graph having the plots of FIG. 4A, but also having further images that represent the improved tests results by introducing the new foam detecting technique/algorithm in the LWCO device firmware according to the present invention. For example, FIG. 4B shows the burner OFF at about location 50 on the X axis and has an arrow that points to the lower threshold T_{L} of the gauge 46 (FIG. 3), also shows the burner ON at about location 162 on the X axis and has a corresponding arrow that points to the upper threshold T_{U} of the gauge 46 (FIG. 3).

FIG. 4B also includes dashed boxes indicating the following: (1) disturbances in the individual ADC data for successive samples on channels Ch1 & Ch2 and (2) a difference between ADC Ch1 & Ch2 samples amplified at the same instant for turning OFF the burner around the location 50; and also indicates (3) an in-water condition and water stability check for turning ON the burner around the location 162.

### FIG. 5: Controller 100

By way of example, FIG. 5 shows a LWCO 100 having a signal processor or processing module 102 configured to implement the steps 20a through 20j and the steps 30a through 30s set forth in FIGS. 2A and 2B in conjunction with the test setup shown in FIG. 3.

In summary, by way of example, and according to the present invention, the signal processor or processing module 102 may be configured to
1. receive signaling containing information about a difference in conductance between samples of a foam/unstable fluid line that are measured on at least one ADC channel and sensed by the probe arranged inside a boiler, e.g., including a steam or hot water boiler or burner; and
2. provide corresponding signaling containing information to turn OFF the boiler, based upon the signaling received.

The functionality of the one or more signal processor or processing modules 102 may be implemented in whole or in part using using hardware, software, firmware, or a combination thereof, although the scope of the invention is not intended to be limited to any particular embodiment thereof. In a typical software implementation, a signal processor or processing module, e.g., like element 102, may take the form of one or more microprocessor-based architectures having a processor or microprocessor, a random access memory (RAM), a read only memory (ROM), where the RAM and ROM together form at least part of a memory for storing a computer program code, input/output devices and control, data and address buses connecting the same. A person skilled in the art would be able to program such a microprocessor-based implementation with the computer program code to perform the functionality described herein without undue experimentation. The scope of the invention is not intended to be limited to any particular implementation using technology either now known or later developed in the future. Moreover, the scope of the invention is intended to include the signal processor or processing module being a stand-alone module, or in some combination with other circuitry for implementing another module. Moreover still, the scope of the invention is not intended to be limited to any particular type or kind of signal processor or processing module used to perform the signal processing functionality, or the manner in which the computer program code is programmed or implemented in order to make the signal processor operate.

The signal processor or processing module, e.g., like element 102, may include one or more other sub-modules for implementing other functionality that is known in the art, but does not form part of the underlying invention per se, and is not described in detail herein. For example, the functionality of the one or more other sub-modules may include the techniques for the receiving signaling, provisioning of corresponding signaling for turning ON/OFF the burner based on certain processing control functionality, including providing the signal automatically, providing the signal after a certain time period, etc., that can depend on a particular application for a particular customer.

The signal processor or processing module may also be configured to implement the underlying signal processing functionality in combination with other signal processor circuits or components 104, e.g., including input/output modules, memory modules, data, address and control busing architecture, etc.

### Foam Detection Algorithms

The present invention may be used alone or together with one or more other foam detection algorithms that are known in the art. The scope of the invention is not intended to be limited to any particular type or kind of known foam detection algorithm, e.g., including those either now known or later developed in the future.

Foam detection algorithm-1 shown in steps 20d and 20g in FIG. 2A may include, or take the form of, one or more such known foam detection algorithms.

### Steam and Hot Water Boilers/Burner

Steam and hot water boilers/burners are known in the art, and the scope of the invention is not intended to be limited to any particular type or kind either now known or later developed in the future.

### ADC

By way of example, during testing of the present invention the inventors used ADC, which is a foaming agent that is known in the art as Azodicarbonamide. However, the scope of the invention is not intended to be limited to using any particular type or kind of foaming agent for testing that is known in the art either now or later developed in the future.

### Measuring Conductance

Techniques for measuring conductance of a foam/unstable fluid line using a probe arranged inside a boiler are known in the art, and the scope of the invention is not intended to be limited to any particular type or kind thereof either now known or later developed in the future.

### The Scope of the Invention

Further still, the embodiments shown and described in detail herein are provided by way of example only; and the scope of the invention is not intended to be limited to the particular configurations, dimensionalities, and/or design details of these parts or elements included herein. In other words, a person skilled in the art would appreciate that design changes to these embodiments may be made and such that the resulting embodiments would be different than the embodiments disclosed herein but would still be within the overall spirit of the present invention.

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein and thereto without departing from the spirit and scope of the present invention.

1. A low water cutoff (LWCO) device having a probe, comprising:
a signal processor or processing module configured to
receive signaling containing information about a difference in conductance between samples of a foam/unstable fluid line for a predetermined foam difference count that are measured on at least one test channel and sensed by the probe arranged inside a boiler, including a steam or hot water boiler or burner; and
provide corresponding signaling containing information to turn OFF the boiler, based upon the signaling received.

2. A LWCO device according to claim 1, wherein the signaling contains information about successive samples measured on one test channel.

3. A LWCO device according to claim 2, wherein the one test channel is either a first test channel or a second test channel.

4. A LWCO device according to claim 1, wherein the signaling contains information about simultaneous samples measured at the same instant on different test channels.

5. A LWCO device according to claim 4, wherein the different test channels are a first test channel and a second test channel.

6. A LWCO device according to claim 1, wherein the signal processor or processing module is configured to
make a comparison of at least five samples and determine a maximum peak value for two test channels; and
if the maximum peak value is greater than a predetermined allowable limit, then provide the corresponding signaling.

7. A LWCO device according to claim 6, wherein the signal processor or processing module is configured to determine a percentage difference based upon the following relationship:
$$\frac{\begin{matrix}Abs ( 1 st test channel measurement - \\ 2 nd test channel measurement )\end{matrix}}{1 st test channel measurement} ;$$
$$or$$
$$\frac{\begin{matrix}Abs ( 1 st test channel measurement - \\ 2 nd test channel measurement )\end{matrix}}{2 nd test channel measurement} .$$

8. A LWCO device according to claim 1, wherein the signal processor or processing module is configured to
make a comparison between a present test measurement and an average of previous test measurement value; and
if the comparison is less that a predetermined percentage for a predetermined Delay on Break (DOM) time, then provide the corresponding signaling signaling containing information to turn ON the boiler, based upon the comparison.

9. A LWCO device according to claim 8, wherein the signal processor or processing module is configured to make the comparison based upon the following relationship:
$$\frac{\sum Previous test channel measurements ( N )}{N} .$$

10. A LWCO device according to claim 9, wherein N is at least 5.

11. A method to detect the presence of a foam/unstable fluid line in a boiler using low water cutoff (LWCO) device having a probe, comprising:
receiving, with a signal processor or processing module, signaling containing information about a difference in conductance between samples of a foam/unstable fluid line for a predetermined foam difference count that are measured on at least one test channel and sensed by the probe arranged inside a boiler, including a steam or hot water boiler or burner; and
providing, with the signal processor or processing module, corresponding signaling containing information to turn OFF the boiler, based upon the signaling received.

12. A method according to claim 11, wherein the signaling contains information about successive samples measured on one test channel.

13. A method according to claim 12, wherein the one test channel is either a first test channel or a second test channel.

14. A method according to claim 11, wherein the signaling contains information about simultaneous samples measured at the same instant on different test channels.

15. A method according to claim 14, wherein the different test channels are a first test channel and a second test channel.

16. A method according to claim 11, wherein the method includes configuring the signal processor or processing module to
make a comparison of at least five samples and determine a maximum peak value for two test channels; and
if the maximum peak value is greater than a predetermined allowable limit, then provide the corresponding signaling.

17. A method according to claim 16, wherein the method includes configuring the signal processor or processing module to determine a percentage difference based upon the following relationship:
$$\frac{\begin{matrix}Abs ( 1 st test channel measurement - \\ 2 nd test channel measurement )\end{matrix}}{1 st test channel measurement} ;$$
$$or$$
$$\frac{\begin{matrix}Abs ( 1 st test channel measurement - \\ 2 nd test channel measurement )\end{matrix}}{2 nd test channel measurement} .$$

18. A method according to claim 11, wherein the method includes configuring the signal processor or processing module to
make a comparison between a present test measurement and an average of previous test measurement value; and
if the comparison is less that a predetermined percentage for a predetermined Delay on Break (DOM) time, then provide the corresponding signaling signaling containing information to turn ON the boiler, based upon the comparison.

19. A method according to claim 18, wherein the method includes configuring the signal processor or processing module to make the comparison based upon the following relationship:
$$\frac{\sum Previous test channel measurements ( N )}{N} .$$

20. A method according to claim 19, wherein N is at least 5.
